(19) United States
(12) Patent Application Publication
(10) Pub. No.: US 2007/0017145 A1
(43) Pub. Date: Jan. 25, 2007

(54) Scented fishing tackle and method of making the same

(76) Inventors: David E. Burt, Galion, OH (US); Jonathon C. Burke, Hillsboro, OH (US)

Correspondence Address: Porter, Wright, Morris & Arthur LLP;ATTN: Intellectual Property Department, 28th Floor, 41 South High Street, Columbus, OH, 43215-6194, US

(21) Appl. No.: 11/188,132

(22) Filed: Jul. 22, 2005

(51) Int. Cl. A01K 85/01

(52) U.S. Cl. 43/42.53; 43/42.06; 43/42.32

(57) ABSTRACT

A method of making fishing tackle includes the steps of providing a body having an exterior surface, covering at least a portion of the exterior surface of the body with a mixture of paint and a scent attractive to fish, and allowing the scented paint to dry on the exterior surface to form a scented paint coating. Also disclosed is fishing tackle including a body having an exterior surface and a scented paint coating covering at least a portion of the exterior surface of the body. The scented paint coating includes a mixture of paint and scent attractive to fish.

### CROSS-REFERENCE TO RELATED APPLICATIONS

Not Applicable.

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to fishing tackle and, more particularly, to fishing tackle having a fish attracting scent.

### BACKGROUND OF THE INVENTION

The sport of angling or fishing becomes more sophisticated as anglers learn more about the sport and the behavior of fish. Artificial lures, jigs, and the like were developed because they are easier to obtain and maintain than natural fishing bait such as, for example, live worms, minnows, shad, shrimp, crayfish, and insects. Numerous artificial lures, jigs, and the like have been developed including flies made of plastic, bird feathers or down, worms made of plastic or rubber, plugs made of plastic or wood, and jigs made of metal. These artificial lures, jigs, and the like often resemble a crayfish, insect, tadpole, worm, or other prey commonly eaten by at least one type of fish.

While these artificial lures, jigs, and the like may visually resemble natural bait, they typically do not emanate a scent resembling natural bait or emit sound resembling natural bait. Fish are primarily attracted to food or prey by scent and sound and thus are less likely seek out unnaturally scented and sounding artificial lures, jigs, and the like than they are to seek out natural bait. Therefore, anglers have begun to treat artificial lures, jigs, and the like with various scents intended to attract fish. These artificial lures, jigs, and the like are typically sprayed or dipped with the scents and in some cases the artificial lures, jigs, and the like are soaked in the scents so that the artificial lures, jigs, and the like absorb the scents.

Unfortunately, the useful life of these scented artificial lures, jigs, and the like is relatively short because the scent is quickly washed away by the water. Therefore, the scents must be continually reapplied to the artificial lures, jigs, and the like on a regular basis. In some cases the scents must be reapplied as often as every twenty minutes or less. This is particularly true for artificial lures, jigs, and the like formed of metal, or other generally nonabsorbent materials, because the metal cannot absorb the scents. Some attempts have been made to solve this problem by providing absorbent materials, absorbent inserts, or absorbent coatings but these still act as reservoirs which must be replenished. Accordingly, there is a need in the art for improved artificial fishing tackle having a scent attractive to fish.

### SUMMARY OF THE INVENTION

The present invention provides artificial fishing tackle and a method of making the same which overcomes at least some of the above-noted problems of the related art. According to the present invention, a method of making fishing tackle comprises the steps of providing a body having an exterior surface, covering at least a portion of the exterior surface of the body with a mixture of paint and a scent attractive to fish, and allowing the scented paint to dry on the exterior surface to form a scented paint coating.

According to another aspect of the present invention, a method of making fishing tackle comprises the steps of providing a metal body having an exterior surface, covering at least a portion of the exterior surface of the body with a mixture of paint and a scent attractive to fish, and allowing the scented paint to dry on the exterior surface to form a scented paint coating. The method also includes the steps of covering the scented paint coating with a mixture of clear paint and a scent attractive to fish and allowing the scented clear paint to dry on the scented paint coating to form a scented clear coating. The scented paint coating and the scented clear coating are non water soluble.

According to yet another aspect of the present invention, fishing tackle comprises a body having an exterior surface and a scented paint coating covering at least a portion of the exterior surface of the body. The scented paint coating comprises a mixture of paint and scent attractive to fish.

From the foregoing disclosure and the following more detailed description of various preferred embodiments it will be apparent to those skilled in the art that the present invention provides a significant advance in the technology of scented artificial fishing tackle. Particularly significant in this regard is the potential the invention affords for providing high quality, reliable, scented artificial fishing tackle with improved life and performance. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a perspective view of an initial stage of a scented fishing jig according to a preferred embodiment of the present invention;

FIG. 2 is a perspective view of the scented fishing jig of FIG. 1 wherein a weed guard and rattle have been attached;

FIG. 3 is a perspective view of the scented fishing jig of FIGS. 1 and 2 wherein scented paint has been applied;

FIG. 4 is a perspective view of the scented fishing jig of FIGS. 1 to 3 wherein a skirt has been attached;

FIG. 5 is a cross-sectional view taken along line 5-5 of FIG. 3;

FIG. 6 is a block diagram illustrating a preferred method of making the scented fishing jig of FIGS. 1 to 5; and

FIG. 7 is a perspective view of scented fishing tackle according to other preferred embodiments of the present invention.

It should be understood that the appended drawings are not necessarily to scale, presenting a somewhat simplified representation of various preferred features illustrative of the basic principles of the invention. The specific design features of scented artificial fishing tackle as disclosed herein, including, for example, specific dimensions, orientations, locations, scents, colors, and shapes of the various components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF CERTAIN PREFERRED EMBODIMENTS

It will be apparent to those skilled in the art, that is, to those who have knowledge or experience in the technology of scented artificial fishing tackle, that many uses and design variations are possible for the improved scented artificial fishing tackle disclosed herein. The following detailed discussion of various alternative and preferred embodiments will illustrate the general principles of the invention with reference to a scented artificial fishing jig having a metal body. Other embodiments suitable for other applications will be apparent to those skilled in the art given the benefit of this disclosure such as, for example, hooks, lures, spoons, swivels weights, spinner bait, buzz bait, live-head jig heads, minnow-imitation bait, and the like.

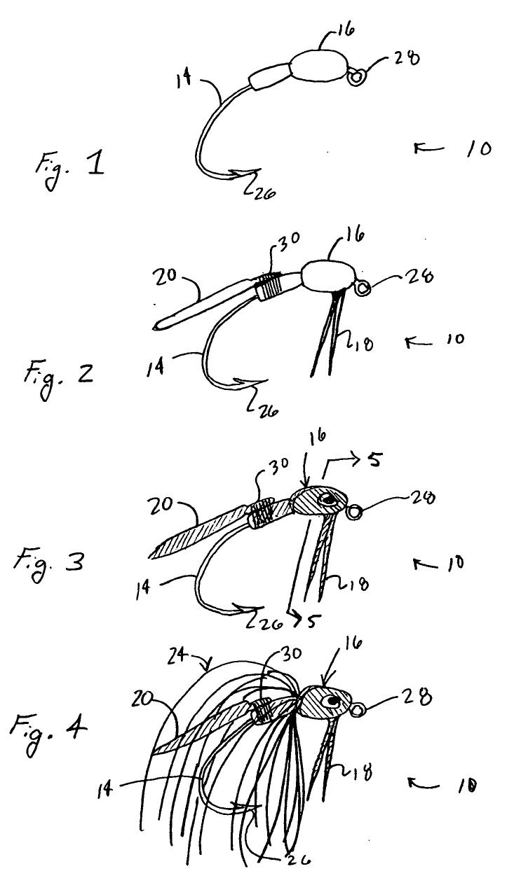

Referring now to the drawings, FIGS. 1 to 6 illustrate making a scented artificial fishing jig 10 according to a preferred embodiment of the present invention. The fishing jig 10 is painted with at least one layer or coating 12 of scented paint to provide both a desired appearance and a desired scent for attracting fish to the artificial fishing jig 10. The coating 12 of scented paint is a permanent part of the fishing jig 10 so that the desired scent lasts a substantially longer period of time than sprays, coatings, dippings, or other forms of scents that must be replenished.

The illustrated scented artificial fishing jig 10 includes a hook 14, a body 16 formed on the hook 14, a weed guard 18 attached to the body 16, a rattler or rattle 20 attached to the body 16, the scented paint coating 12, a layer or coating 22 of scented clear paint located over the scented paint coating 12, and a skirt 24 attached to the body 16. As best shown in FIG. 1, the hook 14 is generally hook shaped having a first end with a sharp point 26 and a second end with an eyelet 28 for securing a fishing line or the like thereto. The hook 14 is preferably formed of a metal such as, for example, steel. It is noted that any suitable type of hook 14 can be utilized within the scope of the present invention.

As best shown in FIG. 1 the illustrated body 16 is formed onto the hook 14 between the eyelet 28 and the sharp point 26. The illustrated body 16 is shaped to simulate a head and a portion of a body of a crayfish and is located near the eyelet 28 of the metal fishing hook 14. It is noted, however, that any other suitable shape for the body 16 can be alternatively utilized. The body 16 is preferably formed of a metal such as, for example, lead and is preferably molded or soldered onto the metal fishing hook 14. It is noted, however, that any other suitable material and/or forming method for the body 16 can be alternatively utilized. It is also noted that the body 16 can be eliminated if desired.

As best shown in FIG. 2, the illustrated weed guard 18 is secured to the body 16. The illustrated weed guard 18 includes a pair of elongate members forming a “V-shape” and extending from the body 16 toward a point in front of the sharp point 26 of the hook 14. It is noted, however, that any other suitable shape for the wed guard 18 can be alternatively utilized. The weed guard 18 is sized and shaped to reduce the likelihood of weeds or other plant life or debris from being pierced by sharp point 26 the hook 14 during use. The weed guard 18 is preferably formed of a metal but any other suitable material can be alternatively utilized. The weed guard 18 is preferably secured to the body 16 by soldering but can alternatively be secured in any other suitable manner. It is noted that any suitable type of weed guard 18 can be utilized within the scope of the present invention.

As best shown in FIG. 2, the illustrated rattle 20 is also secured to the body 16. The illustrated rattle 20 is a generally elongate member and extends from the body 16 in a direction away from the eyelet 28 of the metal fishing hook 14 and generally parallel to a shank of the metal fishing hook 14 and the body 16. The rattle 20 is adapted to make sounds attractive to fish when the scented artificial fishing jig 10 is in use. The rattle 20 is preferably formed of a metal such as, for example, aluminum but any other suitable material can be alternatively utilized. The rattle 20 is preferably tied to the body 16 by a thread, string, line, or any other suitable flexible member 30 but the rattle 20 can alternatively be secured to the body 16 in any other suitable manner. It is noted that any suitable type of rattle 20 can be utilized within the scope of the present invention.

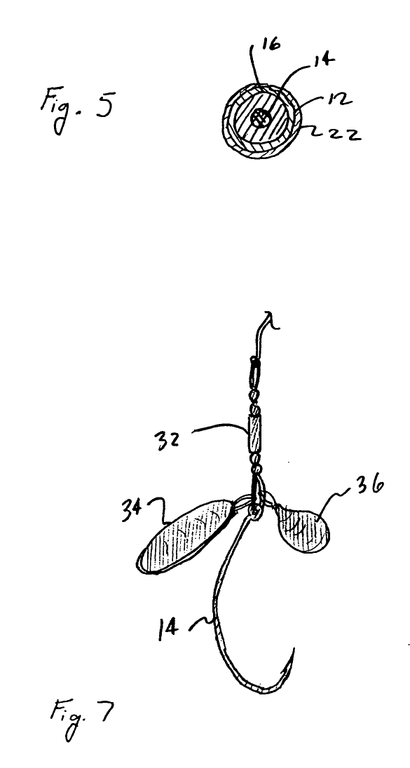

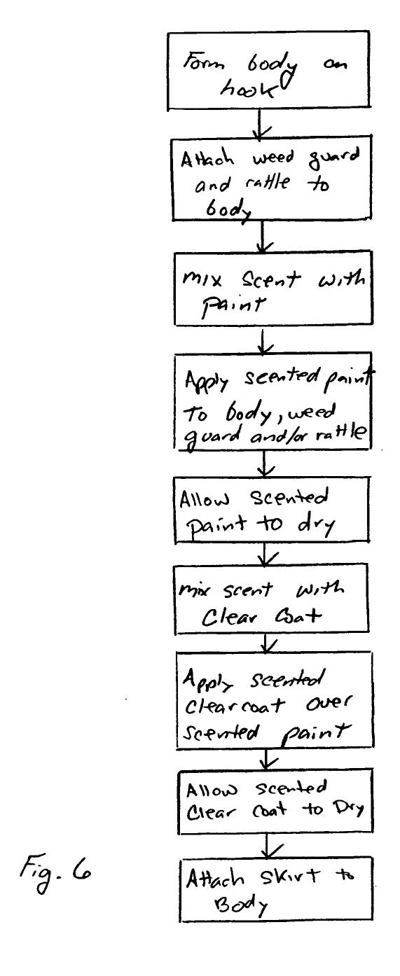

As best shown in FIG. 3 and 5, the coating 12 of scented paint of the illustrated artificial fishing jig 10 is applied to the exterior surfaces of the body 16, the weed guard 18, and the rattle 20. It is noted that while the illustrated coating entirely covers the exterior surfaces of the body 16, the weed guard 18, and the rattle 20, the scented paint coating 12 can alternatively cover the all or any portion of the exterior surface of all or any combination of the components including the hook 14. The scented paint coating 12 is applied to the exterior surface of the components to provide both a desired appearance for attracting fish and a desired scent for attracting fish. The scented paint coating 12 preferably provides an exterior finish which is not water soluble and is nonabsorbent so that the scent is not affected by use over substantial periods of time in water. The illustrated scented artificial fishing jig 10 is painted to have an appearance resembling a crayfish but any other desired appearance can be utilized within the scope of the present invention.

Prior to applying the scented paint coating 12, a desired scent (preferably in liquid form) is mixed into liquid paint so that the scent is thoroughly mixed throughout the liquid paint. The scented liquid paint is then applied to the exterior surface of the fishing jig 10. The scent remains on the fishing jig 10 once the scented paint coating dries. The paint can be any suitable paint or other surface coating for making the artificial fishing jig 10 attractive to fish. The scent can be any suitable scent for making the artificial fishing jig 10 attractive to fish.

For example, the artificial fishing jig 10 can be painted with a white vinyl lure and jig finish or paint which is commercially available. The white vinyl paint provides a base coat for the artificial fishing jig 10. Prior to application, a scent in the form of anise oil is mixed into the white vinyl paint. A mixture of one gram of anise oil per one ounce of paint provides desirable results. It is noted, however, that other suitable mixtures of the oil and paint are within the scope of the present invention. Once the mixture of scent and paint is applied to form the base coat, it is left to air-dry for an adequate period of time such as, for example, two hours. Once the base coat of scented paint is thoroughly dry, the artificial fishing lure 10 is ready for additional coats of scented paint as needed to provide the desired appearance. The additional coats of scented paint are of whatever colors are desired such as, for example, brown or black and are preferably mixed with the anise oil prior to application the same as the base coat described above. These additional coats can be utilized to provide features of natural bait such as, for example, eyes, body features or markings, wings, or the like as desired. Once all of the additional coats of scented paint are applied and air dried, the artificial fishing jig 10 is preferably painted with the coating 22 of scented clear gloss finish or paint. The scented clear coating 22 is preferably mixed with the anise oil prior to application the same as the base coat described above. Once the scented clear coating 22 has been applied, the fishing jig is left to completely air-dry for a suitable period of time such as, for example, ten to fourteen days. It is noted that once the scented paint dries, the anise scent becomes a permanent part of the fishing jig, that is, the scent does not have to be reapplied to artificial the fishing jig 10. While the scent is preferably provided in each of the coats of paint, the scent can alternatively be provided in only one or any number of coats of paint.

While the above illustrated example utilizes vinyl paint as the paint, it is noted that any other desirable surface coating can be utilized such as, for example, enamel paint, acrylic paint, or the like. While the above illustrated example utilizes anise oil as the scent, it is noted that any other desirable scent can be utilized such as, for example, grape, garlic, crawfish, shrimp, cricket, shad, cinnamon, cherry, or the like. The grape scent is preferably added only to dark color paints such as black, blue, or grape because it is believed to discolor light color paints. It is noted that once the scented paint coating dries, the grape scent also becomes a. permanent part of the artificial fishing jig 10, that is, the scent does not have to be reapplied to artificial the fishing jig 10. The garlic scent can be added to any color paint such as, for example, black, blue, red, watermelon, and brown because it is believed to have minimal effect of the color of the paint. Garlic scent can be obtained by mixing garlic scented Dip-N-Glo lure dye with the paint. Dip-N-Glo lure dye is available form Spike-It Outdoors, Inc. of Brooklet, Georgia. It is noted that once the scented paint coating dries, the garlic scent also becomes a permanent part of the artificial fishing jig, that is, the scent does not have to be reapplied to artificial the fishing jig 10. Regardless of the scent utilized, the fishing jig 10 is preferably assembled and finished as described above.

As best shown in 4, the legged skirt 24 is attached to the body 16 to provide the desired appearance once the scented paint coatings 12, 22 are finished and completely dry. The illustrated legged skirt has a plurality of elongate flexible legs similar to a “grass hula skirt”. The elongate flexible legs can be formed of any one or combination of silicone, rubber, or any other suitable material. It is noted that the skirt 24 can alternatively have any other suitable shape and/or can alternatively be made of any other material. The skirt 24 is preferably tied to the body 16 by a thread, string, line, or any other suitable flexible member but the skirt 24 can alternatively be secured to the body 16 in any other suitable manner. It is noted that any suitable type of skirt 24 or the like can be utilized within the scope of the present invention.

FIG. 7 illustrates scented fishing tackle components according to additional preferred embodiments. The illustrated scented fishing tackle components include a hook 14, a swivel connector 32, a spoon 34, and a weight or sinker 36. Each of the illustrated components 14, 32, 34, 36 are formed of a metal and are covered with the scented paint coating 12 and the scented clear coating 22 as described hereinabove. These components illustrate that the scented paint coating 12 can be advantageously utilized on exterior surfaces of many types of fishing tackle other than the illustrated fishing jig 10.

From the foregoing disclosure and detailed description of certain preferred embodiments, it is apparent the scent becomes a permanent part of the fishing tackle by mixing scent oils or other forms of scent with paint or other surface coatings prior to application of the paint. No additional spray or dipping formulas are needed to scent the fishing lure. The fishing tackle produced by the above described method have been soaked in water overnight for about twelve hours with no apparent change to its scent. Therefore, by painting a desired appearance, permanently providing a desired scent, and providing a rattle with a desired sound, the above-described scented artificial fishing jig 10 uses all three basic instincts that fish, such as Bass, use for survival (sight, smell, and sound) to obtain improved results in attracting fish. It is also apparent that this provides a simple method of providing a scent onto a metal surface or other type of generally nonporous material that cannot be utilized to absorb and at least temporarily hold a scent or to even porous materials. For example, metals such as lead, titanium and steel, plastics, rubbers, woods, or any other suitable material can be utilized

From the foregoing disclosure and detailed description of certain preferred embodiments, it is apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

1. A method of making fishing tackle comprising the steps of, in combination:
providing a body having an exterior surface;
covering at least a portion of the exterior surface of the body with a mixture of paint and a scent attractive to fish;
wherein the paint comprises at least one of vinyl paint, enamel paint, and acrylic paint;
allowing the scented paint to dry on the exterior surface to form a scented paint coating;
using the body to produce at least one of an artificial fishing jig, hook, swivel connector, spoon, and sinker; and
wherein the scent is smelled by fish when the body is in water to attract fish to the body.

2. The method according to claim 1, wherein the body comprises metal.

3. The method according to claim 1, wherein the scented paint coating is non water soluble.

4. (canceled)

5. The method according to claim 1, wherein the scent comprises at least one of anise, grape, garlic, crawfish, shrimp, cricket, shad, cinnamon, cherry.

6. (canceled)

7. The method according to claim 1, further comprising the steps of covering the scented paint coating with a mixture of clear paint and a scent attractive to fish and allowing the scented clear paint to dry on the scented paint coating to form a scented clear coating.

8. The method according to claim 1, wherein the scent comprises scent oil.

9. Fishing tackle produced according to the method of claim 1.

10. (canceled)

11. Fishing tackle comprising, in combination:
a body having an exterior surface;
a scented paint coating covering at least a portion of the exterior surface of the body; and
wherein the scented paint coating comprises a mixture of paint and scent attractive to fish;
wherein the paint comprises at least one of vinyl paint, enamel paint, and acrylic paint;
wherein the fishing tackle is at least one of an artificial fishing jig, hook, swivel connector, spoon, and sinker; and
wherein the scent is smelled by fish when the body is in water to attract fish to the body.

12. The fishing tackle according to claim 11, wherein the body comprises metal.

13. The fishing tackle according to claim 11, wherein the scented paint coating is non water soluble.

14. (canceled)

15. The fishing tackle according to claim 11, wherein the scent comprises at least one of anise, grape, garlic, crawfish, shrimp, cricket, shad, cinnamon, cherry.

16. (canceled)

17. The fishing tackle according to claim 11, further comprising a scented clear coating covering at least a portion of the scented paint coating and wherein the scented clear coating comprises a mixture of clear paint and scent attractive to fish.

18. The fishing tackle according to claim 11, wherein the scent comprises scent oil.

19. The fishing tackle according to claim 11, further comprising a rattle attached to the body and wherein the scented paint coating covers at least a portion of the rattle.

20. The fishing tackle according to claim 11, further comprising a weed guard attached to the body and wherein the scented paint coating covers at least a portion of the weed guard.

21. The method according to claim 1, wherein there is no apparent change to the scent when the body is in water for at least 12 hours.

22. The method according to claim 1, wherein the step of allowing the scented paint to dry includes the step of air drying the scented paint.

23. (canceled)

24. The fishing tackle according to claim 11, wherein there is no apparent change to the scent when the body is in water for at least 12 hours.
